(19) United States
(12) Patent Application Publication
(10) Pub. No.: US 2016/0224308 A1
(43) Pub. Date: Aug. 4, 2016

(54) INDICATED READING RATE SYNCHRONIZATION

(71) Applicant: Kobo Incorporated, Toronto (CA)

(72) Inventors: Heather PIERCE, Toronto (CA); Courtney TODERASH, Toronto (CA)

(73) Assignee: Kobo Incorporated, Toronto (CA)

(21) Appl. No.: 14/608,524

(22) Filed: Jan. 29, 2015

(51) Int. Cl. G06F 3/16; G06F 3/01

(52) U.S. Cl. CPC G06F 3/165; G06F 3/013

(57) ABSTRACT

A method and system for indicated reading rate synchronization on a computing device is disclosed. The system utilizes a camera that tracks an eye movement of a user on a page of content on the computing device. In addition, an audio pronouncer is used to pronounce a word on the page of content. A gaze to page portion correlation logic correlates the audio pronouncement of the word on the page with the eye movement tracking location on the page of content on the computing device, such that the word being viewed by the user is the word being announced by the audio pronouncer.

### TECHNICAL FIELD

Examples described herein relate to a system and method for providing indicated reading rate synchronization.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reading device) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device, according to an embodiment.

FIG. 2 depicts a block diagram of a system for operating an electronic personal display, according to one embodiment.

FIG. 3 depicts a diagram of an electronic personal display with reading rate synchronization, according to one embodiment.

FIG. 4 depicts a flowchart of a method for indicated reading rate synchronization, according to one embodiment.

### DESCRIPTION OF EMBODIMENTS

Unless specifically stated otherwise as apparent from the following discussions, it is appreciated that throughout the present Description of Embodiments, discussions utilizing terms such as “tracking,” “correlating,” “implementing,” “executing,” “storing,” “training,” “opening,” “selecting,” “closing,” “scrolling,” “displaying,” “turning,” “adding,” “turning off,” “changing,” “setting,” “illuminating,” “performing,” or the like, often refer to the actions and processes of an electronic computing device/system, such as an electronic media providing device, electronic reader (“eReader”), computer system, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

Electronic books (also known as “e-books”) and electronic games are in a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete successive pages.

An “e-reading device,” also referred to herein as an electronic personal display, can refer to any computing device that can display or otherwise render an e-book or games. According to one embodiment, the electronic media providing device is an “e-reading device” that is used for rendering e-books. Although many embodiments are described in the context of an e-reading device, an electronic media providing device can have all or a subset of the functionality of an e-reading device.

By way of example, an electronic media providing device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultramobile computing device, or a wearable computing device with a form factor of a wearable accessory device (e.g., smart watch or bracelet, glasswear integrated with a computing device, etc.). As another example, an e-reading device can include an e-reading device, such as a purpose-built device that is optimized for an e-reading experience (e.g., with E-ink displays). In another example, the mobile computing device may include an application for rendering content for a game.

One or more embodiments described herein provide that methods, techniques and actions performed by a computing device are performed programmatically, or as a computer-implemented method. Programmatically means through the use of code or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

### Overview of Discussion for Operating an Electronic Personal Display Using Eye Movement Tracking

An e-reading device is operated using a camera of an e-reading device to track a user's eye movement. Based on the tracking, the user's gaze is correlated with a selectable region of the e-reading device. Responsible to the gaze being correlated with the selectable region for at least a predetermined time, an operation of the e-reading device is implemented wherein the operation is associated with the selectable region. Various embodiments do not require any external device, such as eye wear, as apart of tracking the user's eye movement. However, an external device may be used.

Electronic games and electronic books are examples of electronic media. Although various embodiments are described in the context of an electronic book, embodiments are also well suited for other types of electronic media such as electronic games.

Examples of an e-reading device are mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like). According to one embodiment, a request to open media on the e-reading device is detected and a scent is sprayed in response to the detecting of the request to open the media.

### System and Hardware Description

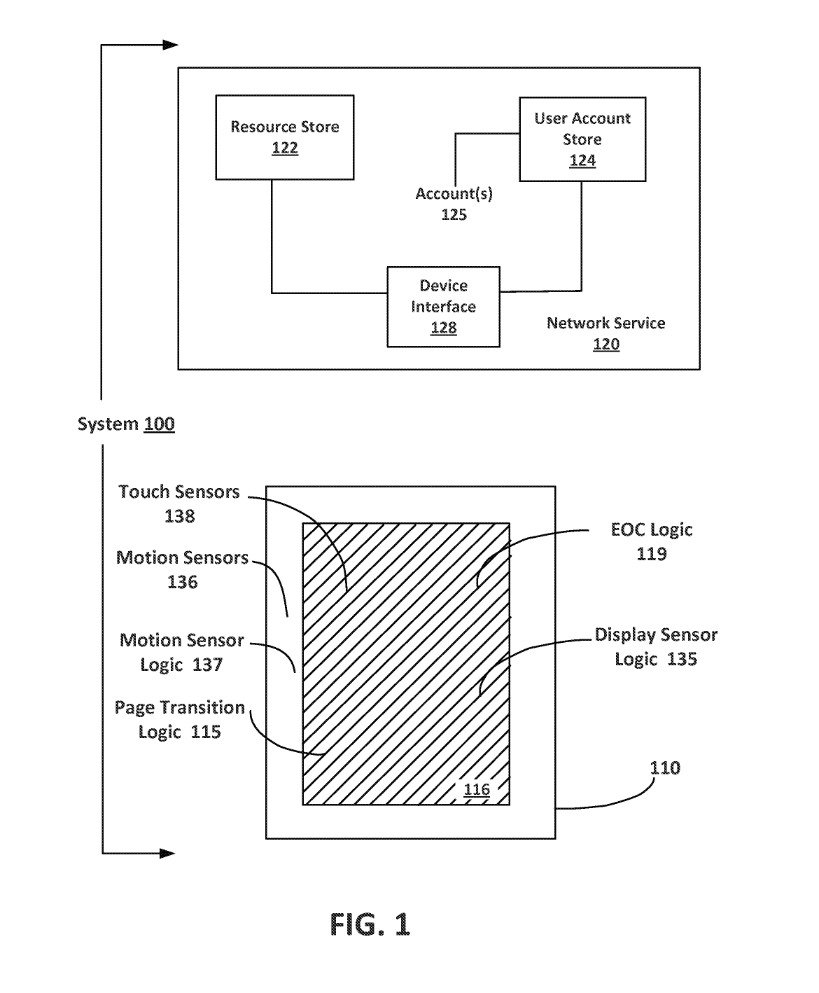

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading device application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with user account 125. The user account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the resource store 122, which can include, for example, an online store. The device interface 128 can handle input to identify content items (e.g., e-books), and further to link content items to the user account 125.

As described further, the user account store 124 can retain metadata for user account 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display 116 and a housing. In an embodiment, the display 116 is touch-sensitive, to process touch inputs including gestures (e.g., swipes). For example, the display 116 may be integrated with one or more touch sensors 138 to provide a touch sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can also be integrated with touch sensors to provide one or more touch sensing regions, for example, could be on a bezel and/or back surface of the housing.

In some embodiments, the e-reading device 110 includes features for providing functionality related to displaying paginated content. The e-reading device 110 can include page transition ing logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116.

E-reading device 110 can also include one or more motion sensors 136 arranged to detect motion imparted thereto, such as by a user while reading or in accessing associated functionality. In general, the motion sensor(s) 136 may be selected from one or more of a number of motion recognition sensors, such as but not limited to, an accelerometer, a magnetometer, a gyroscope and a camera. Further still, motion sensor 136 may incorporate or apply some combination of the latter motion recognition sensors.

In an accelerometer-based embodiment of motion sensor 136, when an accelerometer experiences acceleration, a mass is displaced to the point that a spring is able to accelerate the mass at the same rate as the casing. The displacement is then measured thereby determining the acceleration. In one embodiment, piezoelectric, piezoresistive and capacitive components are used to convert the mechanical motion into an electrical signal. For example, piezoelectric accelerometers are useful for upper frequency and high temperature ranges. In contrast, piezoresistive accelerometers are valuable in higher shock applications. Capacitive accelerometers use a silicon micro-machined sensing element and perform well in low frequency ranges. In another embodiment, the accelerometer may be a micro electro-mechanical systems (MEMS) consisting of a cantilever beam with a seismic mass.

In an alternate embodiment of motion sensor 136, a magnetometer, such as a magnetoresistive permalloy sensor can be used as a compass. For example, using a three-axis magnetometer allows a detection of a change in direction regardless of the way the device is oriented. That is, the three-axis magnetometer is not sensitive to the way it is oriented as it will provide a compass type heading regardless of the device's orientation.

In another embodiment of motion sensor 136, a gyroscope measures or maintains orientation based on the principles of angular momentum. In one embodiment, the combination of a gyroscope and an accelerometer comprising motion sensor 136 provides more robust direction and motion sensing.

In yet another embodiment of motion sensor 136, a camera can be used to provide egomotion, e.g., recognition of the 3D motion of the camera based on changes in the images captured by the camera. In one embodiment, the process of estimating a camera's motion within an environment involves the use of visual odometry techniques on a sequence of images captured by the moving camera. In one embodiment, it is done using feature detection to construct an optical flow from two image frames in a sequence. For example, features are detected in the first frame, and then matched in the second frame. The information is then used to make the optical flow field showing features diverging from a single point, e.g., the focus of expansion. The focus of expansion indicates the direction of the motion of the camera. Other methods of extracting egomotion information from images, method that avoid feature detection and optical flow fields are also contemplated. Such methods include using the image intensities for comparison and the like.

According to some embodiments, the e-reading device 110 includes display sensor logic 135 to detect and interpret user input or user input commands made through interaction with the touch sensors 138. By way of example, the display sensor logic 135 can detect a user making contact with the touch sensing region of the display 116. More specifically, the display sensor logic 135 can detect taps, an initial tap held in sustained contact or proximity with display 116 (otherwise known as a “long press”), multiple taps, and/or swiping gesture actions made through user interaction with the touch sensing region of the display 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to presence of water and/or other extraneous objects on the surface of the display 116.

E-reading device 110 further includes motion gesture logic 137 to interpret user input motions as commands based on detection of the input motions by motion sensor(s) 136. For example, input motions performed on e-reading device 110 such as a tilt, a shake, a rotation, a swivel or partial rotation and an inversion may be detected via motion sensors 136 and interpreted as respective commands by motion gesture logic 137.

E-reading device 110 further includes extraneous object configuration (EOC) logic 119 to adjust one or more settings of the e-reading device 110 to account for the presence of water and/or other extraneous objects being in contact with the display 116. For example, upon detecting the presence of water and/or other extraneous objects on the surface of the display 116, the EOC logic 119 may power off the e-reading device 110 to prevent malfunctioning and/or damage to the e-reading device 110. EOC logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 136 will now be associated with any given input command previously enacted via the touch sensors 138 and display sensor logic 135. This enables a user to continue operating the e-reading device 110 even with the water and/or other extraneous objects present on the surface of the display 116, albeit by using the alternate type of user interaction.

In some embodiments, input motions performed on e-reading device 110, including but not limited to a tilt, a shake, a rotation, a swivel or partial rotation and an inversion may be detected via motion sensors 136 and interpreted by motion gesture logic 137 to accomplish respective output operations for e-reading actions, such as turning a page (whether advancing or backwards), placing a bookmark on a given page or page portion, placing the e-reading device in a sleep state, a power-on state or a power-off state, and navigating from the e-book being read to access and display an e-library collection of e-books that may be associated with user account store 124.

### Discussion of System for Operating an Electronic Personal Display Using Eye Movement Tracking

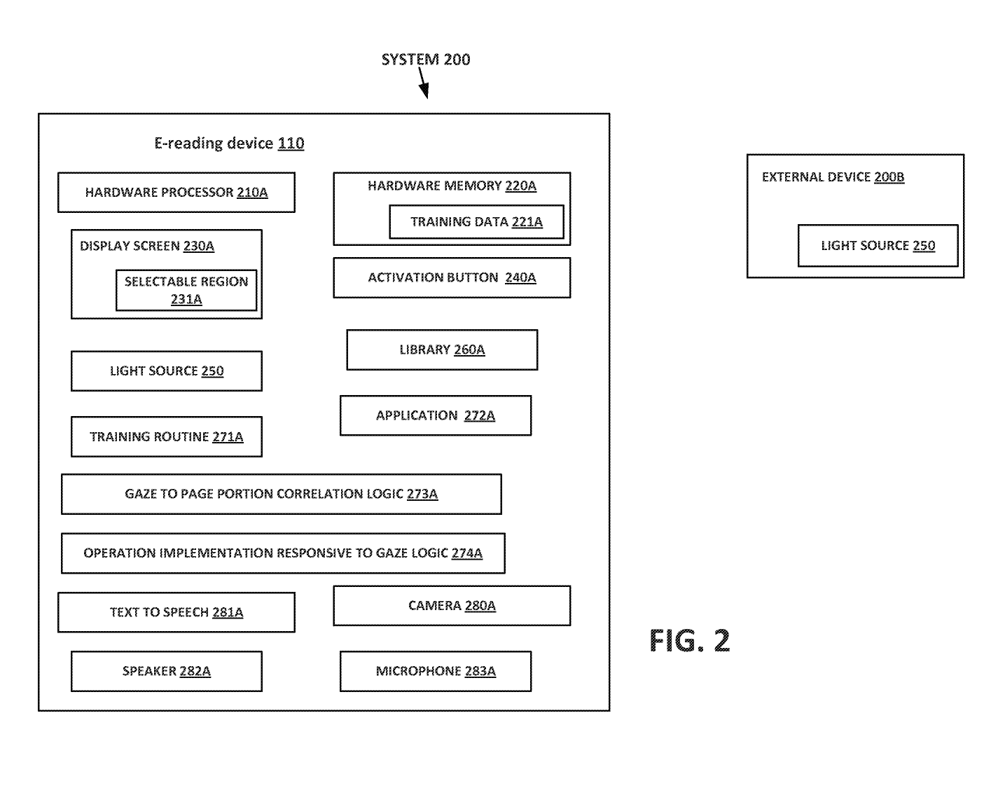

FIG. 2 depicts a block diagram of a system for operating an e-reading device 110, according to one embodiment.

The blocks that represent features in FIG. 2 can be arranged differently than as illustrated, and can implement additional or fewer features than what are described herein. Further, the features represented by the blocks in FIG. 2 can be combined in various ways. The system 200 can be implemented using software, hardware, hardware and software, hardware and firmware, or a combination thereof. Further, unless specified otherwise, various embodiments that are described as being a part of the system 200, whether depicted as a part of the system 200 or not, can be implemented using software, hardware, hardware and software, hardware and firmware, or a combination thereof.

The system depicted in FIG. 2 includes an e-reading device 110 and an optional external device 200B. The e-reading device 110 includes at least one hardware processor 210A, at least one hardware memory 220A, a display screen 230A, a selectable region 231A, a camera 280A, a text to speech 281A, at least one speaker 282A, a microphone 283A, an optional light source 250, an activation button 240A, gaze to page portion correlation logic 273A, operation to implementation responsive to gaze logic 274A, an application 272A, a library 260A, training data 2211A and a training routine 271A. The selectable region 231A is displayed on the display screen 230A. The hardware processor 210A, the hardware memory 220A, the display screen 230A, the camera 280A and the activation button 240A are examples of hardware. The hardware memory 220A may include one or more of the library 260A, the application 272A, the logics, media, the training routine 271A, and training data 221A. The hardware processor 210A, according to one embodiment, can execute at least one or more of the application 272A, the logics, and the training routine 271A.

The optional external device 200B may include a light source 250. Examples of an external device 200B are a hat, a head band, or a pair of eye glasses that include a light source 250. One or both of the light sources 250 depicted in the e-reading device 110 and the external device 200B may be used. The external device 200B is not required. In one embodiment, text to speech 281A performs text analysis and provides a spoken output for the word or words in the text that was analyzed. In one embodiment, speaker 282A may be an actual speaker fixedly coupled with e-reading device 110. In another embodiment, speaker 282A may be an external speaker that is connected wired or wirelessly with e-reading device 110; such as via Bluetooth, Wifi, audio port, usb port, communications port, and the like.

According to various embodiments, the camera 280A tracks eye movement of a user of the e-reading device 110. The gaze to page portion correlation logic 273A correlates a gaze of the user with a selectable region 231A of the e-reading device 110. The operation implementation responsive to gaze logic 274A implements an operation of the e-reading device 110 in response to the gaze being correlated with the selectable region 231A for at least a predetermined time.

The camera 280A may be either an infrared camera or a non-infrared camera. The camera 280A may include one or more light emitting diodes or laser diodes that illuminate a viewing location. The light emitting diodes may be infrared light emitting diodes or infrared laser diodes. The light source(s) 250 may be infrared or non-infrared. The light source 250 maybe part of the e-reading device 110 or part of the external device 200B that is external with respect to the e-reading device 110. A light source 250 illuminates at least one eye of the user. The light source 250 may illuminate either eye or both eyes of the user. The light source 250 may continuously illuminate the at least one, for example, while an application 272A is open or may intermittently illuminate the at least one eye while the application 272A is open. An example of intermittently is turning the light source 250 on every one or two seconds. An example of an application 272A is an application for reading an electronic book. Another example of an application 272A is an application for playing an electronic game. In another embodiment.

The light source 250 may be positioned along an optical axis that is the same for the camera 280A, according to one embodiment. However, the light source 250 may be placed elsewhere so that the light source 250 is not required to be positioned along an optical axis that is the same for the camera 280A.

The training data 221A, according to one embodiment, is created by executing a training routine 271A on the e-reading device 110 to model the tracking and correlation with respect to the e-reading device 110. The training routine 271A may reside on the e-reading device 110 or reside remotely and be accessed over a network, such as the Internet.

According to various embodiments, eye tracking is turned on in response to an application 272A being opened or in response to the e-reading device 110 being turned on. According to various embodiments, eye tracking is turned off in response to an application 272A being close or in response to the e-reading device 110 being turned off. According to various embodiments, turning the eye tracking on does not disable or turn off other types of controls, such as mouse, touch input or physical keyboard.

The system depicted in FIG. 2 may include one or more of the features described in the context of FIG. 1.

### Examples of Eye Gaze that Initiate an Operation

Table 1 describes examples of eye gazes that initiate operations. Col. 1 is for the operations and Col. 2 is for the eye gazes. Each row correlates one operation with one eye gaze that would initiate the operation in the same row.

Various entries refer to the “current page.” The “current page” is the page that is currently displayed on the display screen 230A, according to one embodiment.

TABLE 1
examples of eye gazes that initiate operations.

| OPERATION | EYE GAZE |
|---|---|
| 1) Turn page in increasing order | Gaze in a region to the right of the current |
| | page. The region can be pre-positioned on |
| | each page, electronically via a semi- |
| | translucent icon or indicator. The region |
| | can be registered on the e-reading device |
| | display screen 230A. |
| 2) Turn page in decreasing order | Gaze in a region to the left of the current |
| | page. Region can be pre-positioned on |
| | each page, electronically via a semi- |
| | translucent icon or indicator. The region |
| | can be registered onto the region on the e- |
| | reading device display screen 230A. |
| 3) Turn pages quickly | Continuous gaze on the region to the left |
| | of the current page to turn pages quickly in |
| | decreasing order or continuous gaze on the |
| | region to the right of the current page to |
| | turn pages quickly in increasing order. |
| 4) Cause a menu to be displayed or cause a webpage | Gaze on the text in the current page for a |
| to be displayed | predetermined time that a user would click |
| | on to cause the menu or the webpage to be |
| | displayed. |
| 5) Bookmark a current page | Gaze at the top right corner of the current |
| | page. |
| 6) Dismiss a currently displayed item, such as an | Move the eye away from the currently |
| option/menu/Widipedia. | displayed item in less than the |
| | predetermined time. |
| 7) Cause an operation to be performed that normally | Gaze at the key that the user wants to be |
| requires user input from a keyboard, such as adding | entered or gaze at a word or phrase in a |
| notes, selecting a word from a displayed list, | displayed list for at least a predetermined |
| changing text size, changing text style, change | time. For example, the user can type by |
| alignment, changing margins, changing day or night | gazing at keys of a virtual keyboard in a |
| reading mode, changing theme, change zoom, | sequentially manner to type a word. More |
| selecting yes or no to a question. | specifically, gaze at L, then O, then V, |
| | then E to spell love. |
| 8) Scroll pages in a library 260A of books | Move eye from left to right or from top to |
| | bottom or vice versa will scroll the books |
| | in a library 260A. The pace of the |
| | scrolling can be controlled, for example to |
| | a predefined number of books, such as 10 |
| | books, for each time the gaze is moved in |
| | a direction. |
| 9) Open an item, such as a menu, view details, to | Gazing at a region that a user would |
| mark an item as complete, or to delete an item from a | manually interact with to cause the |
| library 260A. | operation for a predetermined time. Move |
| | gaze away from that region so that the |
| | operation is not performed. |
| 10) Open a book from the beginning or to continue | Gaze at the entry for the book for a |
| reading from where stopped during a previous | predetermined time and double blink |
| reading. | during that predetermined time. |
| 11) Searching a book for occurrences of a string of | Gaze at the appropriate keys of a visual |
| text. | representation of a keyboard displayed on |
| | the display screen 230A to type the letters, |
| | numbers, symbols in the desired string of |
| | text. |
| 12) Scroll through entries of books in an Online e- | Move eye from left to right, top to bottom |
| BookStore | or vice versa to scroll through the online |
| | bookstore in the direction that the user |
| | desires. |
| 13) Display details of a desired book in the Online E- | Gaze at the entry for that book in the |
| BookStore. | online bookstore for a predetermined time. |
| 14) Add a book as a preview in the Online e- | Gaze at the entry for the book in the online |
| BookStore | bookstore for a predetermined time and |
| | blink once during that predetermined time. |
| 15) Add a book to the shopping cart of the Online e- | Gaze at the entry for the book in the online |
| BookStore. | bookstore for a predetermined time and |
| | blink twice during that predetermined |
| | time. |
| 16) Perform quick buy or regular purchase path. | Gaze on text, such as “buy book,” that |
| | represents the operation to quick buy or |
| | perform regular purchase for at least a |
| | predetermined time. |
| 17) Turn eye tracking off. | Either gaze at an option to turn eye |
| | tracking off or eye tracking will |
| | automatically turn off after a period of |
| | time, such as at least 5 minutes, after the |
| | user stops gazing at material of a displayed |
| | e-book application. |

Several operations described in Table 1 refer to a predetermined time. An example of the predetermined time is at least 3 seconds.

Operations 7-11 can be used as a part of library management, according to various embodiments.

Operations 12-16 can be used as a part of purchasing an electronic book from an online e-BookStore, according to various embodiments. Similar types of operations could be performed for purchasing an electronic game from an electronic game store.

According to one embodiment, Table 1 represents a library 260A of entries correlating each electronic personal display operation with a pattern of eye movement. For example, each row in table 1 could represent an entry, where each entry correlates an electric personal display operation described in Col. 1 of Table 1 with a pattern of eye movement, which is described in Col. 2 of Table 1.

### Page Continuity Bookmark Indicium and Invocation

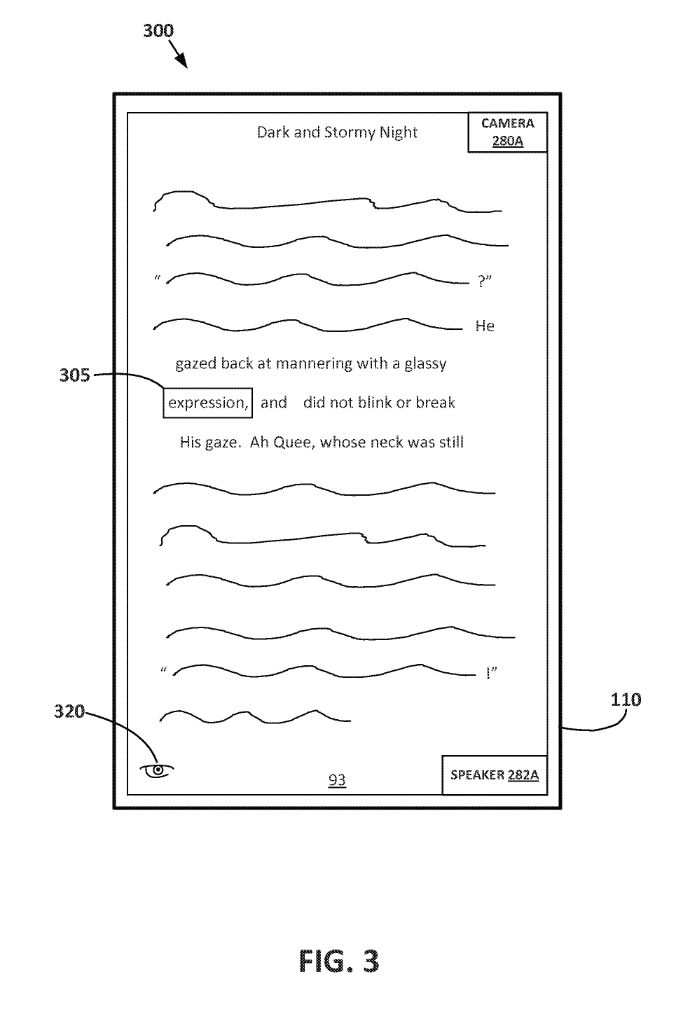

FIG. 3 is a diagram of an e-reading device screen according to an embodiment. In FIG. 3, the e-reading device 110 is presenting a page 300 of an e-book. FIG. 3 includes camera 280A, speaker 282A, location 305, and optional icon 320. In one embodiment, icon 320 is optionally provided on the screen to indicate that eye movement tracking functionality is enabled.

Using eye-tracking or similar technology such as via camera 280A, the e-reading device 110 determines the location 305 at which the user's eyes are presently reading. In addition, an audio pronouncer, e.g., text to speech 281A, pronounces the word being viewed via speaker 282A. For example, in FIG. 3 at location 305 the word “expression” is being viewed by the reader. As such, the word “expression” would also be being pronounced by the audio pronouncer via speaker 282A.

In one embodiment, location 305 may also be marked, such as, but not limited to, highlighting, bolding, illuminating, pulsating or the like. In one embodiment, by marking the location 305 the user would be certain that the word they are hearing being pronounced is the word they are actually reading.

In addition, in one embodiment, if the reader's gaze leaves the page for longer than a pre-defined period of time. The e-reading device automatically marks location 305. In one embodiment, location 305 remains marked even if the device enters a sleep state or is powered off. Thus, the user does not lose their place in the page content no matter the length or nature of the distraction requiring them to look away from e-reading device 110. In one embodiment, location 305 is automatically unmarked after the reading experience resumes.

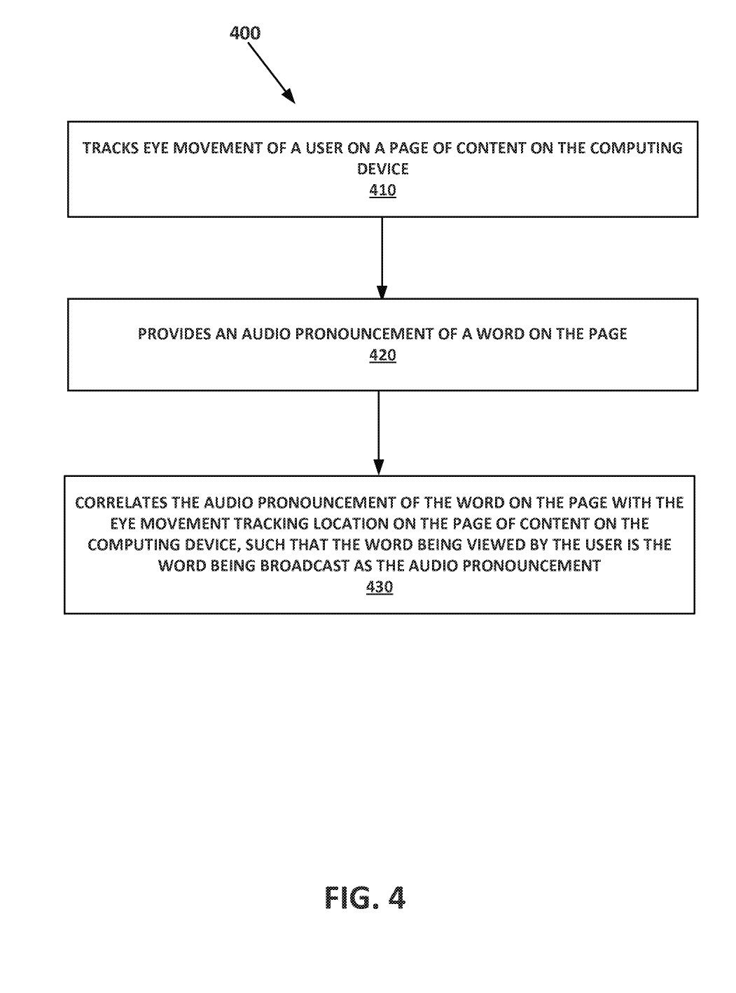

FIG. 4 depicts a flowchart for a method automatically marking a portion of a page of content on an e-reading device 110 for page continuity, according to one embodiment. In one embodiment, for example, user eye-tracking is used to gauge a user's actual reading progress and provide a correlated audio word pronunciation. In so doing, learning readers with attendant audio, or users learning/reading additional languages will be provided with an audio pronunciation of the word at which they are looking and at a pace that matches their personal reading pace. In addition, word highlighting may also be used to provide positive feedback to the user that, the word being pronounced by the computing device is actually the word being read by the user.

Although specific operations are disclosed in flowchart 400, such operations are exemplary. That is, embodiments of the present invention are well suited to performing various other operations or variations of the operations recited in flowchart 400. It is appreciated that the operations in flowchart 400 may be performed in an order different than presented, and that not all of the operations in flowchart 400 may be performed. In one embodiment, system 200 depicted in FIG. 2 performs the method depicted in flowchart 400.

According to one embodiment, prior to performing the method of flowchart 400, a training routine 271A is executed to model the tracking and correlation with respect to the e-reading device 110. The training routine 271A creates training data 221A, which represents the model, during the execution of the training routine 271A. In one embodiment, eye tracking may be automatically turned on in response to the application 272A being opened.

Referring now to 410 of FIG. 4, one embodiment tracks eye movement of a user on a page of content of a computing device. In one embodiment, an icon 320 on the page of content 300 is used to indicate that the tracking of the eye movement of the user is enabled. The tracking may be line-by-line granularity, word-by-word granularity, and the like.

For example, the eye movement may be tracked with a camera 280A of the e-reading device 110 as described herein. In one embodiment, camera 280A may be infrared or non-infrared. According to an embodiment, an eye of the user is illuminated with a light emission from a light source 250. For example, the light source 250 may also be used that assists the camera in tracking eye movement of the user. The light source 250 may illuminate one or both eyes of the user. If a single eye is tracked, then the single eye may be either eye of the user. The light source 250 may be infrared or non-infrared. The light source 250 may be part of the e-reading device 110 or separate from the e-reading device 110, for example, in an external device 200B. In general, video images or still images or both can be used for tracking the one or more eyes of the user.

With reference now to 420 of FIG. 4, one embodiment provides an audio pronouncement of a word on the page. For example, a new reader or someone learning a new language would be able to see the words on the page while also hearing the words being pronounced properly. In so doing, the user would be able to learn the visual cues of the word while also learning the proper pronunciation. In one embodiment, the audio pronouncement is provided serially such as in a word progressive format. That is, once the audio pronouncement begins on a page each word on the page is pronounced in its proper order.

In another embodiment, the audio pronouncement may be set to a more progressive setting such that it only pronounces words that a user is struggling with. For example, the user may set the progressive setting such that after it is determined that the eye movement of the user has paused on a word on the page of content on the computing device for a given period of time, an audio pronouncement of the word would be provided. For example, if a user is looking at a word for longer than 2 seconds (or a user defined or factory default time period), the word would be pronounced by the audio pronouncer. In so doing, an intermediate reader would be able to read without every word being pronounced while still having the helpful pronouncement of words with which the user struggles.

With reference now to 430 of FIG. 4, one embodiment correlates the audio pronouncement of the word on the page with the eye movement tracking location on the page of content on the computing device, such that the word being viewed by the user is the word being broadcast as the audio pronouncement. For example, in word progressive audio pronouncement, the audio pronouncer would have a certain default, or user selected, speaking pace. However, the default or user selected pace will not be an exact match to each reader. By correlating the eye movement tracking of the words the user is viewing with the words being pronounced, the user wilt not fall behind or race ahead of the word progressive audio pronouncement. Instead, the speed of the word progressive audio pronouncement will be automatically adjusted to correlate with the user's actual reading location.

Moreover, an embodiment can determines, via the eye movement tracking, that the user has looked away from the page being read. Upon making the determination that the user has looked away, the word progressive audio pronouncement performed by the computing device can be automatically paused. For example, the user eye movement tracking has determined that the user read to location 305 of FIG. 3. After reading to that point, the user's eyes were no longer looking at the page. The user may have looked away, fallen asleep, or the like. After a pre-defined or user customizable period of time, e.g., 4 seconds or the like, of the user's eyes no longer looking at the page, the gaze to page portion correlation logic 273A of FIG. 2 would signal that the user is no longer looking at the page and also denote the last location 305 that the user viewed.

In addition, one embodiment marks a portion of the page 300 presented on the e-reading device 110, relative to a last eye movement tracking location on the page of content on the e-reading device 110 before the user's gaze was averted and the word progressive audio pronouncement was paused. In general, the marking may be: highlighting, bolding, italicizing, illuminating, pulsating, or the like. By marking the next-segment-of-text 310, when the user returns to looking at the e-reading device 110, they will be able to quickly identify their place on the page. Thus, the user would not need to search for their place in the page content. Moreover, since the marking remains even if the device enters standby or is turned off they will be able to find their place again even if the distraction caused them to be away from the e-reading device 110 for a significant amount of time.

Further, one embodiment automatically unmarks the portion of the page presented on the e-reading device and automatically resuming the word progressive audio pronouncement being performed by the computing device, when the eye movement tracking determines the user has returned to looking at the page being read. That is, the marked portion of the page has been viewed. For example, once next-segment-of-text 310 has been determined to have been viewed by gaze to page portion correlation logic 273A, the marked next-segment-of-text 310 will be automatically unmarked and the word progressive audio pronouncement will recommence.

### Computer Readable Medium

Unless otherwise specified, any one or more of the embodiments described herein can be implemented using non-transitory computer-readable storage medium and computer readable instructions which reside, for example, in computer-readable storage medium of a computer system or like device. The non-transitory computer readable storage medium can be any kind of physical memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present invention are realized, in one embodiment, as a series of computer readable instructions (e.g., software program) that reside within non-transitory computer readable storage memory of a computer system and are executed by the hardware processor 210A of the computer system. When executed, the instructions cause a computer system to implement the functionality of various embodiments of the present invention. For example, the instructions can be executed by a central processing unit associated with the computer system. According to one embodiment, the non-transitory computer readable storage medium is tangible. The non-transitory computer readable storage medium is hardware memory 220A.

Unless otherwise specified, one or more of the various embodiments described in the context of FIGS. 1-4 can be implemented as hardware, such as circuitry, firmware, or computer readable instructions that are stored on non-transitory computer readable storage medium. The computer readable instructions of the various embodiments described in the context of FIGS. 1-4 can be executed by a hardware processor 210A, such as central processing unit, to cause a computer system to implement the functionality of various embodiments. For example, according to one embodiment, the logics and the operations are implemented with computer readable instructions that are stored on computer readable storage medium that can be tangible or non-transitory or a combination thereof.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with one or more other features, structures, or characteristics.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for indicated reading rate synchronization on a computing device, the method comprising:
tracking an eye movement of a user on a page of content on the computing device;
providing an audio pronouncement of a word on the page; and
correlating the audio pronouncement of the word on the page with the eye movement tracking location on the page of content on the computing device, such that the word being viewed by the user is the word being broadcast as the audio pronouncement.

2. The method as recited by claim 1, further comprising:
providing an icon on the page of content indicating that the tracking of the eye movement of the user is enabled.

3. The method as recited by claim 1, further comprising:
tracking the eye movement of the user at a word-by-word granularity.

4. The method as recited by claim 1, further comprising:
determining that the eye movement of the user has paused on a word on the page of content on the computing device; and
providing an audio pronouncement for the word.

5. The method as recited by claim 1, further comprising:
providing a word progressive audio pronouncement of each word on the page.

6. The method as recited by claim 5, further comprising:
determining, via the eye movement tracking, that the user has looked away from the page being read; and
automatically pausing the word progressive audio pronouncement performed by the computing device.

7. The method as recited by claim 6, further comprising:
automatically resuming the word progressive audio pronouncement performed by the computing device, when the eye movement tracking determines the user has returned to looking at the page being read.

8. A system for indicated reading rate synchronization on a computing device, the system comprising:
a camera that tracks an eye movement of a user on a page of content on the computing device;
an audio pronouncer to pronounce a word on the page of content; and
a gaze to page portion correlation logic to correlate the audio pronouncement of the word on the page with the eye movement tracking location on the page of content on the computing device, such that the word being viewed by the user is the word being announced by the audio pronouncer.

9. The system of claim 8, further comprising:
a word highlighter to highlight the word being pronounced by the audio pronouncer.

10. The system of claim 8, further comprising:
an icon on the page of content indicating that the tracking of the eye movement of the user is enabled.

11. The system of claim 8, wherein the camera tracks the eye movement of the user of the computing device at a word-by-word granularity.

12. The system of claim 8, wherein the camera tracks the eye movement of the user of the computing device at a line-by-line granularity.

13. The system of claim 8, wherein the audio pronouncer provides a word progressive audio pronouncement of each word on the page.

14. The system of claim 13, wherein the camera that tracks the eye movement of the user determines that the user has looked away from the page being read; and
the gaze to page portion correlation logic automatically pauses the word progressive audio pronouncement.

15. The system of claim 13, wherein the camera that tracks the eye movement of the user determines that the user has resumed looking at the page; and
the gaze to page portion correlation logic automatically resumes the word progressive audio pronouncement.

16. A non-transitory computer-readable storage medium storing instructions that, when executed by a hardware processor of an e-reading device, cause the hardware processor to perform a method for indicated reading rate synchronization, the method comprising:
tracking an eye movement of a user on a page of content on the e-reading device;
providing an audio broadcast of a word on the page; and
correlating the audio broadcast of the word on the page with the eye movement tracking location on the page of content on the e-reading device, such that the word being viewed by the user is the word being broadcast.

17. The non-transitory computer-readable storage medium as recited by claim 16, further comprising:
determining that the eye movement of the user has paused on a word on the page of content on the e-reading device; and
providing an audio pronouncement for the word.

18. The non-transitory computer-readable storage medium as recited by claim 16, further comprising:
providing a word progressive audio pronouncement of each word on the page.

19. The non-transitory computer-readable storage medium as recited by claim 16, further comprising:
determining, via the eye movement tracking, that the user has looked away from the page being read; and
automatically pausing a word progressive audio pronouncement performed by the e-reading device.

20. The non-transitory computer-readable storage medium as recited by claim 19, further comprising:
automatically resuming the word progressive audio pronouncement performed by the e-reading device, when the eye movement tracking determines the user has returned to looking at the page being read.
